(19) United States
(12) Patent Application Publication
(10) Pub. No.: US 2025/0162218 A1
(43) Pub. Date: May 22, 2025

(54) BICOLOURED INJECTION-MOULDED PRODUCT AND BI-COLOUR INJECTION-MOULDING METHOD

(71) Applicant: Schoeller Allibert GmbH, Schwerin (DE)

(72) Inventors: Albert Jurgens, Kloosterhaar (NL); Carlos Wever, Hengelo (NL)

(21) Appl. No.: 18/839,094

(22) PCT Filed: Jan. 19, 2023
(86) PCT No.: PCT/EP2023/051201

§ 371 Date: Aug. 16, 2024

(30) Foreign Application Priority Data
Feb. 24, 2022 (EP) 22158667.0

(51) Int. Cl. B29C 45/16; B29C 45/00; B29K 23/00; B29K 105/26; B29L 31/00

(52) U.S. Cl. CPC B29C 45/1634; B29C 45/0001; B29K 2023/065; B29K 2023/12; B29K 2105/26; B29K 2995/0017; B29K 2995/0077; B29K 2995/0089; B29L 2031/712; B29L 2031/7178

(57) ABSTRACT

An injection-molded product of bi- or multicolored appearance includes a first thermoplastic component of a first color that is a base color, and at least one second thermoplastic component of a second color that is different from first color. The injection-molded product also has at least one unmixed, especially unblended, regional domain of only the first or second color. The domain can be uncontaminated by and/or visually distinct from the other color. The first thermoplastic component and the at least one second thermoplastic component are mutually mixable, especially blendable and/or chemically compatible, materials, when in their thermoplastic melted states. An injection-molding method can be used to manufacture the injection-molded product of bi- or multicolored appearance.

### CROSS-REFERENCE TO RELATED APPLICATIONS

This application is the United States national stage entry of International Application No. PCT/EP2023/051201, filed on Jan. 19, 2023, and claims priority to European Application No. 22158667.0, filed on Feb. 24, 2022. The contents of International Application No. PCT/EP2023/051201 and European Application No. 22158667.0 are incorporated by reference herein in their entireties.

### FIELD

The present disclosure relates to an injection-molded product of bi- or multi-color(ed) appearance, especially one displaying intermingling bi- or multi-toned streaks of and/or giving a visual impression of marble or wood. In particular, a bi- or multicolored injection-molded ‘marble’ plastic crate for storage and transport of beverage containers, such as glass bottles for beer or blow-molded PET bottles for still or carbonized water, or a bi- or multicolored injection-molded so-called large transport container, and the like, is provided. Further, a respective method of manufacturing an injection-molded product of bi- or multi-color(ed) appearance is disclosed.

### BACKGROUND

Injection-molded products are well known to a number of rigid plastics industries and in various industrial and/or consumer fields/applications. For example, injection-molded products are commonly used as plastic parts to the automotive industry as well as storage containers or other logistics equipment, such as beer kegs, beverage crates, pallets for warehousing and transportation of products, etc.

For the purpose of manufacturing bi- or multi-color(ed) injection-molded products, the methods of overmolding and/or insertion molding of at least two different thermoplastic (melt) components of different colors in a double- or multi-color injection mold injection mold assembly have been generally known. For example, BR 200605744 A refers to a method for injection of thermoplastic parts with two different colors, or using two different materials by means of traditional injecting equipment of two or more injection cannons, by means of a single template. Said method is disclosed to allow the injection of two identical plastic materials or even of two different materials to be injected simultaneously, while at the same time preventing the occurrence of material contamination.

However, the mold design and/or the layout of the overmolding and/or of the insertion molding process is/are by far more complex, when compared to the injection molding of a standard, i.e. mono-colored, thermoplastic resin. Especially, for each color required in the final product, a designated injection-molding extruder including a separate feed is required, respectively. Hence, this results in disadvantageous bi- or multi-color manufacturing costs.

Another disadvantage of bi- or multi-color(ed) injection-molded products, that are attained by overmolding and/or insertion molding based on at least two different thermoplastic materials/components, lies in the risk of delamination of/within the final product/plastic part, due to the occurrence of mechanical stress and/or shear forces in the course of a user application of the final product such as transport of heavy items. A known major cause for delamination occurring at/along an interface between the at least two different thermoplastic materials/components lies in an unsatisfactory interfacial connection before transitioning from the thermoplastic or molten state to a solidified state inside the injection mold. This is caused by a lack of interfacial coalescence of the two different thermoplastic materials/components and/or by an incomplete/insufficient material bond of these. Especially, upon injection of the at least two different thermoplastic materials/components in their melted state into the injection mold, especially from two different injection nozzles or paths, their at least two (outer) thermoplastic material melt fronts thermally solidify first, such that do not (fully) flow together/combine/coalesce at their interface. Hence, delamination is difficult to suppress.

Further, there are some older so-called ram-injection molding machines that have a process with no extrusion screw, but just a heating chamber and a ram for injection. It is known that it is an uncontrollable drawback of this method that it produces undesired colorless/unpigmented streaks in part if color is used. This disadvantage is due to the lack of efficient mixing, what regards a base material thermoplastic resin usually provided in the form of colorless pellets with a usually small percentage of color pigment pellets added thereto in a feed zone. This lack of homogeneous, thorough coloring/pigmenting on the plastic part has previously been referred to as an undesirable “marbling” effect of unpigmented or very poorly pigmented/unshaded/untoned regions. In other words, these injection-molded products often turn out to contain uncolored regions or domains, remaining uninfluenced from mixing, therefore showing no specific color at all and thus giving an impression of an inferior product quality to a product user or consumer. Further, due to the lack of mixing, the products attainable by this nowadays largely obsolete ram-injection molding technology often show the prohibitive disadvantage of delamination of the final product. In addition, due to the lack of kneading elements in the ram-injection injection molding machine/process, resulting in a disadvantageous separation of heating and flow, the necessary plasticizing is processed very poorly, resulting in regions where prohibitive degradation of the thermoplastic resin caused by overheating of stationary material regions occurs. Therefore, the product appearance, lifetime and mechanical strength are unsatisfactory up to insufficient. Moreover, due to the cycled manner of the injection unit process, production costs are too high.

Consequently, there exists a need to overcome one or more of the disadvantages associated with the prior art of (manufacturing) bi- or multi-color(ed) injection-molded products.

### SUMMARY

The present disclosure was made to solve the afore-mentioned technical problems existing in the prior art and to provide an injection-molded product of bi- or multi-color(ed) appearance of high quality, especially in terms of customer appeal as well as mechanical strength in the application. Specifically, it is a technical object thereof to suppress delamination occurring in previous injection-molded products of at least two thermoplastic components. Another object of the present disclosure is to provide a corresponding method of manufacturing/injection-molding said injection-molded product of bi- or multi-color(ed) appearance which is robust according to potential influences of various input process parameters, yields a high throughput and is cost-effective.

An injection-molded product of bi- or multicolored appearance according to a first aspect of the present disclosure comprises/has: a first thermoplastic component of a first color (especially, pigmented with/by a first color pigmentation/masterbatch) that is a base color, and at least one second thermoplastic component, of another second (second, third, fourth, etc.) color (especially, pigmented with/by another/a second, third, fourth, etc. color pigmentation/masterbatch) that is different to the first color (and/or first color pigmentation/masterbatch). Thereby the injection-molded product of bi- or multicolored appearance has at least one unmixed, especially unblended, regional domain of only one, the first or the (at least one other) second, color (pigmentation/masterbatch). Preferably, the at least one regional domain (or plurality of domains) may be uncontaminated by the other (single or multiple) color/s (pigmentation/s). Alternatively, or cumulatively, preferably, the at least one regional domain (or plurality of domains) may be visually distinct from the other (single or multiple) color/s (pigmentation/s). Thereby, the first thermoplastic component and the at least one second thermoplastic component are mutually mixable materials, when in their thermoplastic melted states. Especially, the first thermoplastic component and the at least one second thermoplastic component may be blendable and/or chemically compatible materials, when in their thermoplastic melted states.

It ought to be understood, that presently the one term “color” should imply a visually distinct appearance to the eye in the sense of a tone/a shade/a hue, while the other, however closely related, term “pigment(ation)” is meant to relate to the material presence of a colorant.

Especially, the terms “another color”/“different colors” may be understood with reference to various color models and/or color matching/reproduction systems as well known in the state of the art. For example, exemplary reference may be made in this context to the “Pantone Matching System®” (by Pantone LLC, Carlstadt, New Jersey, USA), which is a proprietary color space used in a variety of industries, notably including plastics, and distinguishing between 2161 different colors/tones/shades/hues (as of the year 2019). However, presently it may be preferred that the different colors exhibit a strong color contrast, for example by being complementary colors and/or colors contrasted by their lightness/darkness, respectively.

Especially, the term “colorant”/“pigment” means a substance/an additive that imparts the first and the second color, such as black or white or a color to the other materials, i.e. the thermoplastic component, and/or a substance that is or has been added or applied in order to change the initial/natural/inherent coloring of the thermoplastic material that is usually light/pale/“without any color”. Preferably, the colorant may be solid, especially in the form of powdered particles/agglomerates or compounded therefrom into (thermoplastic) colored pellets of the thermoplastic (optionally, thermoplastic compound), creating a masterbatch material.

However, the colorant may also include a liquid or paste-like dye (concentrate) and the like. The pigment(s) used in the thermoplastic may be, respectively, insoluble organic and/or inorganic particles added to the first thermoplastic component and/or the at least one second thermoplastic component to give a specific first and/or respective second (second, third, fourth, etc.) color thereto. The pigment(s) may be selected from one or more of the following pigment categories: organic pigments, inorganic pigments, carbon black, white pigments, special effect pigment, aluminum pigments, and combinations thereof. Especially, it may be preferred, that the pigment(s) is/are heat resistant in polyolefins (for example, according to standard norm EN 12877-2 Procedure A).

The term “(color) masterbatch” thus refers to a solid or liquid colorant/additive for the respective first/second thermoplastic component, used for the coloring thereof. Especially, the (color) masterbatch may be thermoplastic pellets in which pigments are optimally dispersed at high concentration in a carrier material. The carrier material is compatible with the main thermoplastic material in which it will be blended during extrusion/molding. Thereby the respective first/second thermoplastic component obtains the color from the color masterbatch.

The first thermoplastic component may also be referred to as outer phase/matrix material. The at least one second thermoplastic component may also be referred to as inner phase/effect material. For the present disclosure, this technical terminology is derived and ought to be understood as within colloidal chemistry/interfacial physics, for example in the context of emulsions as liquid bi-/multi-phase systems. Also, this includes the technical term “domain” as used herein. The term “domain” thus relates to an island region/volumetric delta unit/droplet (as in a bi-/multi-phase-system). The regional domain may preferably be visually distinct; for example, the regional domain may preferably be of at least 1 mm width/size (with a characteristic/nominal length extending along at least one axis within a surface of the injection-molded product), preferably of at least 5 mm width/size, especially of at least 10 mm width/size. The (plurality of) colored regional domain(s) may be visually distinct as a (plurality of) colored patch(es)/blob(s)/streak(s)/band(s) and the like. The (plurality of) colored regional domain(s) may take various free forms (such as, for example, with an interface curve thereof alternatingly curved/being locally convex and locally concave), such as elongated and/or (quasi/near) round shape. The interfacial surface of the (plurality of) colored regional domain(s) may be/appear (locally) smooth and/or frayed/streaked and the like. The plurality of colored regional domain(s) may occur in swarm-like/concentrated arrangements thereof, for example as multiple streaks, especially extending in essentially the same direction.

The term of “mutually mixable materials (at thermoplastic melted states)” implies that the first thermoplastic component and the at least one second thermoplastic component are melt-extrudable together as an integral bi-/multi-phase system, that is, without the occurrence of any interfacial phase separation effects. This advantageously suppresses any delamination in the solidified final injection-molded product.

Especially, the first thermoplastic component and the at least one second thermoplastic component may be blendable with each other and/or chemically compatible to each other. Especially, the term “blendable” can imply that a difference between respective so-called polymeric solubility parameter “Sp value” of the first thermoplastic component and the at least one second thermoplastic component may not be greater than 4.5 (cal/cc)^{1/2}, more preferably not greater than 1.0 (cal/cc)^{1/2}, especially not greater than 0.1 (cal/cc)^{1/2}. The polymeric solubility parameter (Sp value) is understood by the skilled person as a technical term and defined as the square root of the cohesion energy density (cal/cc) as taught in, for example, “Polymer Handbook, Chapter 4” (ed. by J. Brandrup et al; John Wiley & Sons, Inc., 1967).

Similarly, the technical term “chemically compatible” implies macromolecular considerations (such as non-polar and polar group, intensity of hydrogen bonds, etc). Especially, the first thermoplastic component and the at least one second thermoplastic component are presently considered as “chemically compatible” when they are selected from the same/identical polymer group.

For example, the first thermoplastic component and the at least one second thermoplastic component may both be selected from the group of polyolefins (i.e. polyalkenes; macromolecules formed by the polymerization of olefin/alkene monomer units), in particular polyethylene (PE) and polypropylene (PP); and derivatives and/or compounds/composites thereof. However, it is also conceivable that the first thermoplastic component and/or the second thermoplastic component may be obtained from the same/identical thermoplastic polymer group (and copolymers, derivatives, composites/compounds thereof) including the following ones: polymethylmethacrylate (PMMA); acrylonitrile butadiene styrene (ABS); polyamides; acetal/polyacetal (POM/polyoxymethylene); polyphenylene sulfide (PPS); poly (alkylenes terephthalate), in particular polybutylene terephthalate (PBT); polyurethanes (PUR); and vinyl polymers, polyvinyl chloride (PVC); etc.

Alternatively, or cumulatively, the first thermoplastic component is obtained from at least a base polymer selected from the group of polyethylenes (PE), in particular of high-density polyethylenes (HDPE); and derivatives and/or compounds thereof.

Alternatively, or cumulatively, the at least one second thermoplastic component is obtained from at least a base polymer selected from the group of polyethylenes (PE), in particular of high-density polyethylenes (HDPE); and derivatives and/or compounds thereof.

It could be found that hence the thermoplastic properties/machinability as well as the overall bi-/multicolored appearance, especially a produced effect of artificial marble, as well as the mechanic strength/integrity under tensile loading (i.e. suppressed delamination) turned out to be extraordinarily advantageous.

Accordingly, in the optional case of polyethylene (PE), the polymeric Sp value of the, respectively, first or the (at least one) second thermoplastic component is ca. 8.0 (cal/cc)^{1/2}. Further, the thermophysical properties of high density polyethylene (HDPE) as a preferred embodiment, are as follows:
Density 930 to 970 kg/m³, preferably ca. 940 kg/m³;
Melt density 0.764 g/cm³;
Melting point 110 to 140° C., preferably ca. 130 to 136° C., for example, 135° C. (homopolymer) or
   110-134° C. (copolymer); and/or
Heat of fusion: 245 KJ/kg (homopolymer) or 140-232 KJ/kg (copolymer).

Thereby, the physical term “heat of fusion” is defined as the heat absorbed by a unit mass of a given solid at its melting point that completely converts the solid to a liquid at the same temperature, i.e. equal to the heat of solidification.

Alternatively, or cumulatively, the at least one second thermoplastic component is obtained from at least a base polymer selected from the group of polypropylenes (PP); and derivatives and/or compounds thereof.

Alternatively, or cumulatively, the first thermoplastic component is obtained from at least a base polymer selected from the group of polypropylenes (PP); and derivatives and/or compounds thereof.

Accordingly, in the optional case of polypropylene (PP), the polymeric Sp value of the, respectively, first or (at least one) second thermoplastic component is ca. 7.9 (cal/cc)^{1/2}. Further, the thermophysical properties of polypropylene (PP) as another preferred embodiment, are as follows:
Density 904 to 908 kg/m³;
Melt density 0.739 g/cm³;
Melting point 156 to 210° C., preferably ca. 160 to 170° C., for example, 160-165° C. (homopolymer) or
   135-159° C. (copolymer); and/or
Heat of fusion: 88 KJ/kg.

It could be experimentally found, that these preferred embodiments further improved a forestated advantageous effects, such as the thermoplastic properties/machinability; the overall bi-/multicolored appearance (esp. effect of artificial marble; suppressed delamination).

Especially, in the case of high density polyethylene (HDPE) as one further preferred embodiment for the first thermoplastic component, a specifically preferred first color (esp. matrix color) masterbatch may be made from a polyethylene (PE) carrier. Especially/in addition, the second pigment carrier may be polypropylene (PP), thus creating the marble effect.

Especially, in the case of polypropylene (PP) as another/alternative further preferred embodiment for the first thermoplastic component, a specifically preferred first color (esp. matrix color) masterbatch may be made from a polypropylene (PP) carrier. Especially/in addition, the second pigment carrier may be high density polyethylene (HDPE), thus creating the marble effect.

Alternatively, or cumulatively, the first thermoplastic component has a high first Melt Flow Rate/MFR, in particular as determinable according to DIN EN ISO 1133, that is in a range of 15 to 50 g/10 min, preferably measured at 2.16 kg test load and, in the case of the group of polyethylenes (PE), at 190° C. test temperature. Due to the accordingly low melt viscosity, the machinability/flow behaviour of the outer phase (more relevant thereto) is excellent, thereby suppressing thermal degradation, reducing injection pressure and positively improving the yield/cost situation.

Alternatively, or cumulatively, the at least one second thermoplastic component has a low second Melt Flow Rate/MFR, in particular as determinable according to DIN EN ISO 1133, that is in a range of 0.5 to 5.0 g/10 min, especially of 1.5 to 2.0 g/10 min, preferably measured at 2.16 kg test load and, in the case of the group of polypropylenes (PP), at 230° C. test temperature. Due to the accordingly high melt viscosity of the inner phase, the domains of the at least one second thermoplastic component break up less easily in response to kneading/extrusion shear stress and thus remain large(r). Therefore, the second domains in the final injection-molded product come out/are visually more distinct, for example in the size of several millimeters, especially more than 1 cm. This preferred embodiment very favourably adds to the desired bi-/multicolored appearance (esp. effect of artificial marble).

Alternatively, or cumulatively, the first thermoplastic component has a first melting point or melting point interval, as determinable by DSC (Differential Scanning calorimetry according to DIN EN ISO 11357), that is in the temperature range of 110 to 140° C., preferably ca. 130 to 136° C. It is known that in thermoplastic polymer materials there is a fairly definite softening point that is observed when the thermal kinetic energy becomes high enough to allow internal polymer chain rotation to occur within the polymer chain bonds and to allow the individual polymer molecules to slide independently of their neighbours, thus rendering them more flexible and deformable. This defines the so-called glass transition temperature. Depending on the degree of polymer crystallinity, there will be a (slightly) higher temperature (interval), defining the melting point (interval), at which the polymeric crystalline regions come apart and the material becomes a viscous liquid melt of the thermoplastic polymer material (composition). According to aforesaid optional feature defining a (comparably) low first melting point (interval), the first thermoplastic component, especially in cases when it constitutes the major/highly-concentrated base component, begins to melt early on in an injection unit of an injection-molding machine (assembly), i.e. in a feed hopper zone and/or in an initial zone of the extrusion screw (a first part of a heated barrel zone). This will positively result in a good flow behaviour of the thermoplastic material composition such that this can easily be extruded and/or injected into an injection mold injection mold to manufacture the injection-molded product of bi- or multicolored appearance as objects of various type, shapes and/or sizes. In addition, the injection pressures and/or cycle times can be positively reduced yielding lower investment and manufacturing costs.

Alternatively, or cumulatively, the at least one second thermoplastic component has a respective second melting point or melting point interval, as determinable by DSC (Differential Scanning calorimetry according to DIN EN ISO 11357), that is in the temperature range of 156 to 210° C., preferably ca. 160 to 170° C.

Alternatively, or cumulatively, injection-molded product of bi- or multicolored appearance, wherein the first melting point or melting point interval and the respective second melting point or melting point interval do not overlap, especially differ by a respective delta temperature of at least ca. 10° C., preferably ca. 20° C.

Alternatively, or cumulatively, injection-molded product of bi- or multicolored appearance, comprising the at least one second thermoplastic component with a respective second mass percentage in the range of 0.1 to 5 weight-%, preferably 2 to 3 weight-%. Thereby, the at least one second thermoplastic component is mixed and broken up as an inner phase of the bi-/multi-phase-system wherein the first thermoplastic component is the outer phase thereof.

Especially, within said preferred embodiment (but not in any way limited thereto) it is conceivable to provide more than one/two or more/multiple second thermoplastic component. For example, reference may be made here to FIG. 3 showing, as an example, a tri-colored injection-molded marble-effect product wherein the first thermoplastic component is an essentially outer phase of ocean blue (i.e. in the black and white reproduction: anthracite) as first color, the injection-molded marble-effect product further comprising two separate second thermoplastic components as two essentially inner phases of white as well as of black constituting two different second colors.

Alternatively, or cumulatively, the injection-molded product of bi- or multicolored appearance does not comprise any plasticizers (or at least: does essentially not comprise any plasticizers, i.e. less than 0.1 weight-%, more preferably less than 0.01 weight-%, even more preferably only trace amounts less than 10 ppm). Plasticizers are understood to be additives compounded into thermoplastic materials to render them more flexible by acting as ‘lubricants’ between the polymer chains, thereby lowering the glass transition temperature/melting point (interval). However, it has been found that the (optional) absence of stabilizers may have a further positive effect on what regards the present disclosure. One advantage lies in the further optimized material strength properties and/or absence of delamination issues that can be observed. The applicant assumes that this may be explained, in the macroscopic context of kneading of viscous liquids/melts and shear forces occurring along the interfacial regional domain surfaces, by an absence of slipping/slippage. In addition, the absence of (diffusible) plasticizers in the final product can be positive under considerations of material longevity and/or of the environment.

Alternatively, or cumulatively, the appearance is one of artificial marble or artificial wood. In some situations, it may be preferred that the pigment(s) used in the thermoplastic component(s) may be organic in nature; due to the then low dispersibility/tendency of forming agglomerates/clumps of pigment particles which may add visually observable irregularities such as (tiny) spots and specks, freckles, squirts, splashes, spots to further enhance the heterogeneity of the color appearance. Hence, a marble-effect resembling the visual vividness of natural stones is further improved. Alternatively, or cumulatively, it may be preferred that the pigment(s) used in the thermoplastic component(s) may be inorganic pigments such as metal oxides (e.g. titanium dioxide) and sulphides, carbon black, etc. This yields the advantage of a good dispersibility whereby manufacturing aspects such as the overall machinability, the robustness of the manufacturing process and the resulting good product yield rate are improved resulting in reduced costs.

Especially, for creating said preferred/the appearance as one of artificial marble or of artificial wood:
the first thermoplastic component is high density polyethylene (HDPE) and a masterbatch of the first color is made from a polyethylene (PE) pigment carrier and the second color is made from a polypropylene (PP) pigment carrier; or
the first thermoplastic component is polypropylene (PP) and a masterbatch of the first color is made from a polypropylene (PP) pigment carrier and the second color is made from a high density polyethylene (HDPE) pigment carrier.

Alternatively, or cumulatively, the injection-molded product of bi- or multicolored appearance is a container, pallet, crate and/or peg for storage and/or transportation of goods. This is specifically appealing in the field of consumer products such as beverages.

Alternatively, or cumulatively, the first thermoplastic component and the at least one second thermoplastic component contains at least 90% of a recycled material. Alternatively, or cumulatively, the first thermoplastic component and the at least one second thermoplastic component contains at least 5% of a maritime material. Such preferred embodiments are eco-friendly and more sustainable.

Alternatively, or cumulatively, the injection-molded product of bi- or multicolored appearance is delamination-proof/delamination-free. Especially, one or more of the following material strength parameters or test values apply (without any delamination occurring in respective test probes/samples of the injection-molded product):
Young's Modulus value of at least 800 MPA;
yield strength value of at least 20 MPa;
yield strain value of at least 10%;
elongation value of at least 250%;
Charpy V-notch impact test value of at least 6 KJ/m².

Thereby, the determination methods relating to afore-mentioned material strength parameters are well known in the prior art. Accordingly, the term “delamination-free” marking a distinguished technical advantage of the present disclosure can be easily quantified. In other words, breaking surface lines induced in test samples of the presently disclosed injection-molded product of bi- or multicolored appearance and occurring due to material failure caused by said determination methods will, essentially, cross bi- or multicolored interfaces and not (only) follow along the interfaces (as it does in the case of delamination, cf. the prior art discussion in the introductory part of the present disclosure).

According to a second aspect of the disclosure a method of manufacturing/injection-molding the injection-molded product of bi- or multicolored appearance according to the first aspect of the disclosure is provided. The method of manufacturing/injection-molding includes the following process steps:
feeding, within an initial feed hopper zone of an injection molding machine, the first thermoplastic component and the at least one second thermoplastic component, respectively, into at least one feed hopper to attain a thermoplastic material composition;
extruding the thermoplastic material composition continuously, within a heated barrel zone extending between the feed hopper zone and an injection nozzle of the injection molding machine, by means and along a longitudinally extending extrusion screw to be mixed and plasticized into its molten state;
injection-molding, within an injection mold injection mold zone, the mixed and plasticized thermoplastic material composition, through the injection nozzle into an injection mold, in a timely cycled manner; and
solidification into the final injection-molded product by cooling of the injection mold injection mold and subsequent unloading, in a timely cycled manner.

It ought to be noted, that technical features as well as the technical effects and advantages thereof, as have been described above in relation to the first aspect of the present disclosure of the injection-molded product of bi- or multicolored appearance will equally (mutatis mutandis) be applicable to/valid for this second aspect of the disclosure of the corresponding method of manufacturing/injection-molding and vice versa. Hence, repetition may be avoided.

Thereby, said method of manufacturing/injection-molding is processed/implemented on the injection-molding machine (assembly) including an injection unit and a clamping unit, being (esp. directly following) downstream of the injection unit. On the one hand, the injection unit comprises the feed hopper zone and the (heated) barrel zone, being (esp. directly following) downstream of the feed hopper zone. On the other hand, the clamping unit, which will be described in detail below, comprises the injection mold injection mold zone. Especially, the injection mold injection mold zone may comprise a so-called hot-runner zone located at an entrance flow region of the injection mold injection mold that is downstream/adjacent to the injection nozzle.

The heated barrel zone provides a barrel that is a hollow chamber in which the (at least one) extrusion screw (also referred to as: reciprocating injection screw) operates. The extrusion screw/reciprocating screw is a screw capable of both rotational and axial movement. Thereto, the injection-molding machine (assembly), includes a motor and gears for screw rotation and/or a cylinder for screw ram, which may be arranged upstream to the feed hopper zone. The extrusion screw, arranged within a heated barrel zone of the injection unit, is configured to combine heating and mixing with the function of injection. In a preferred single-screw-extruder embodiment using one extrusion screw, the barrel has a cylindrical cross-section. Alternatively, in another preferred double-screw-extruder embodiment using two extrusion screws, the barrel has a figure-eight-cross-section. The barrel, within the heated barrel zone, is heated by at least one heater arranged to provide a temperature profile (extending along a longitudinal barrel axis/extrusion screw axis).

Within the feed hopper zone, the injection unit includes at least one feed hopper. Into the at least one feed hopper and/or within the feed hopper zone the first thermoplastic component and the at least one second thermoplastic component are fed, especially in the form of solid thermoplastic/polymer pellets. Especially, in order to manufacture a multicolored injection-molded product, (a) further second thermoplastic component(s) that is/are a third, fourth, etc. thermoplastic component(s) may be fed. Thereby, a thermoplastic material composition is (pre-) mixed from the first thermoplastic component and the at least one second thermoplastic component. Feeding may especially be attained by means of (a) so-called feeding screw(s)/barrels extruder(s). Moreover, within the feed hopper zone, the dry blending of the fed materials (the first and the at least one second thermoplastic components and/or of the masterbatches) plays a roll. Therein, preferably, a pellet size, a pellet length and/or a dosage thereof may be (a) key process parameter(s) of the manufacturing method.

For example, alternatively, or cumulatively, the first thermoplastic component may be provided/fed in first (average) pellet size around ca. 3 mm; and/or the at least one second thermoplastic component may be provided/fed in first (average) pellet size around ca. 3 mm or, in a preferred/optional embodiment, around ca. 6 mm (yielding an enhanced/better visually distinguishable regional domain size). However, this is not limiting, and the skilled person understands that the feed hopper may be fed with thermoplastics (resins) or compounds in various forms. In other words, the (respective) feeds may be fine powder, regrind/recycled material or virgin pellets, compound pellets; or a mixture thereof. Especially, the first thermoplastic component and the at least one second thermoplastic component may share one common feed hopper. However, the method is not limited to one common feed hopper; and it is also thinkable to provide two (bi-color) or, respectively, a plurality (multi-color) of separate feed hoppers, especially such that each of the first thermoplastic component and the at least one/plurality of second thermoplastic component(s) are fed into the (upstream/initial part of the) injection-molding machine separately.

Thereby, it is preferred to (optionally) control the ratio(s) of the first thermoplastic component and the at least one second thermoplastic component within the thermoplastic material composition to maintain a consistent injection-molding machine operation and steady-state, superior final product quality/surface appearance. For certain embodiments in the latter case of the provision of a ratio control, it is conceivable that optionally said ratio(s) may fluctuate and/or represent a (respective) time-dependent function, in order to, for example, tailor the attainable optical appearance of the final injection-molded product.

Then, the solid plastic pellets/thermoplastic material composition fed from the feed hopper(s) is/are conveyed to transit into (a first part of) the heated barrel zone. There they are compressed, especially by a change in screw geometry. This compression forces the solid plastic pellets/thermoplastic material composition to melt/plasticize through the action of pushing up against each other. In addition, or rather: in superposition, the imposed temperature profile within the heated barrel zone causes the thermoplastic material composition to melt. In particular, it is the extrusion screw(s) and the (heated) barrel, which are configured, especially interact, to convey, mix, and to generate pressure on thermoplastic material composition within the extruder in order to melt/plasticize.

Thereby, the injection unit is configured to feed (batch-wise or preferably continuously or quasi-/semi-continuously), prepare/plasticize (continuously or quasi-/semi-continuously), and dose the thermoplastic material composition, i.e. a two- or multi-component resin/thermoplastic polymer (pre-) mix, which especially may be consistently and accurately performed. Further, the injection unit is configured to then inject, in a cycled manner, a set volume of the plasticized thermoplastic material composition at a high injection pressure (e.g. 80 bar and up to much higher, such as 100 to 160 bar, dependent on the mold size and injection flow channels, the rheology, etc.) into the mold (tool). Herein, the (technical) term “to plasticize thermoplastic material” means to make the thermoplastic material capable of being injection-molded.

Thereby, according to the present disclosure, the thermoplastic material composition is processed in such a way that a respective (melt flow) viscosity of each of the extruder-mixed first thermoplastic component and the at least one second thermoplastic component are such, at the point of the injection nozzle and/or within the injection mold-zone, especially the hot runner zone, that resulting kneading effects (i.e. interfacial shear-stress effects on/around intra-bulk material regional domains) have caused sufficient inter-mixing of these (such that delamination is prevented or essentially suppressed), but however have been insufficiently achieved with respect to producing a (visually) uniform thermoplastic material composition. Especially, it is preferred that the selection of the first thermoplastic component and/or of the at least one second thermoplastic component and/or of various processing parameters of the injection-molding method may be such as to cause the second (melt flow) viscosity of the at least one second thermoplastic component (especially, when being considered as an inner phase of a bi-/multi phase thermoplastic material composition) to be (significantly) lower than the first (melt flow) viscosity of the first thermoplastic component (especially, when being considered as the outer phase, essentially or at least partially enclosing the inner phase).

Following/downstream of the injection unit, the clamping unit of the injection-molding machine (assembly), that includes the injection mold injection mold zone, comprises (at least one) injection mold. The injection mold is arranged/mounted between a stationary platen and a movable platen by means of (e.g. four) peripheral tie rods, as well as a clamping cylinder and a hydraulic cylinder, which are an arrangement configured/provided to move the movable platen. However, the skilled person will understand, the gist of the present disclosure lies within the technical effects taking place within the injection unit. Especially, it is of importance that the feature defining the at least one unmixed, especially unblended, regional domain of only the first or second color, especially of the second color (i.e. the inner phase), wherein further preferably the regional domain is uncontaminated by and/or visually distinct from the other color, ought to be attained within the thermoplastic material composition at (the longitudinal points of) the injection nozzle and/or within the hot runner zone (corresponding to a respective injection-molding process time). Consequently, any clamping unit known in the prior art may be used equally. In fact, the present disclosure is not in any way limited to a certain type of the injection unit and/or of the clamping unit as these may by varied, according to the size, complexity and/or scale of the final injection-molded product and/or in dependence of the availability of a (historically developed) injection-molding machine park.

Alternatively, or cumulatively, the heated barrel zone provides a process temperature profile that is higher than both the first and the second melting points. This results in high throughputs and supresses fluctuations negatively affecting the machinability. In addition, this enables a favourably longer tool life (extrusion screw and/or injection mold), due to a reduction of melt flow viscosities and resulting injection pressures.

Alternatively, or cumulatively, the heated barrel zone provides a process temperature profile that is set to be in a first part of the heated barrel zone at a first temperature range of 160 to 165° C. Alternatively, or cumulatively, the heated barrel zone provides a process temperature profile that is in a middle part of the heated barrel zone at a second temperature range of 165 to 175° C. Alternatively, or cumulatively, the heated barrel zone provides a process temperature profile that is in a last part of the heated barrel zone/at the injection nozzle at a third temperature range of 175 to 195° C. Especially, but not in any way limiting, it has been found, that this (partial) temperature profile or such a combination of (partial) temperature profiles is especially advantageous to create visually attractive marble-effects in non-delaminating injection-molded products that are based on the first thermoplastic component being selected from the group of polyethylenes (PE) (and the like) and/or on the at least one second thermoplastic component being selected from the group of polypropylenes (PP) (and the like). Alternatively, or cumulatively, this (partial) temperature profile or such a combination of (partial) temperature profiles may be employed for injection-molded products according to the present disclosure wherein the first thermoplastic component has a first melting point (interval) within the temperature range of 110 to 140° C., preferably ca. 130 to 136° C.; and/or wherein the at least one second thermoplastic component has a respective second melting point (interval) within the temperature range of 156 to 210° C., preferably ca. 160 to 170° C. These features cause different interfacial effects to take place within the heated barrel zone. Especially, mixing and the presently disclosed non-mixing of the first and especially the second color masterbatch takes place within the heated barrel zone. In other words, dependent on the temperature profile/curve, be it partial or along the whole barrel, the marble-effect or marble-like effect can be influenced and tailor-made according to customer/user preferences without compromising the mechanic strength/the product requirement of avoided delamination.

Alternatively, or cumulatively, the heated barrel zone provides a process temperature profile that includes a temperature maximum within a hot runner zone that is included within the injection mold zone, especially being provided within an initial flow path region. This serves a short residence time of maximum heat application/exposure. That is, in order to optimize the rheologic behaviour within the injection mold by a further decreased (melt flow) viscosity, the maximum heat is imposed just where this specifically matters (esp., within the initial flow path region), thus without negatively affecting the thermoplastic material composition due to degradation caused by over-heating/longer residence times at the heat maximum. Preferably, the hot runner zone is set to be heated to a fourth temperature range of 180 to 215° C., preferably ca. 185 to 195° C. As a result, the injection cycle time is advantageously reduced further, yielding optimal production costs and reduced maintenance. Alternatively, or cumulatively, the injection speed may be predetermined at 2.5 seconds injection cycle time resulting in improved production costs.

Alternatively, or cumulatively, the extrusion screw may be configured to provide a short (initial/upstream) mixing zone, with the mixing zone length extending maximally up to ca. 30%, especially up to ca. 20%, of the total extrusion screw length (i.e. in longitudinal direction of the injection extruder machine). Alternatively, or cumulatively, the extrusion screw may be a barrier-type extrusion screw. Such (a) preferable, optional extrusion screw design(s) advantageously enable(s) low melt temperatures or temperature profiles along the extrusion screw as well as heterogeneity of the injected melt or, respectively, of the final injection-molded product. While on the one hand, the first thermoplastic component and the at least one second thermoplastic component need to be mixed to a certain extent in the (initial/upstream) mixing zone, it has been found that the desired bi- or multi-color(ed) appearance can be optimally attained by such an optional extrusion screw design. That is, the at least one unmixed, especially unblended, regional domain of only the first or second color remains larger and/or more (visually) distinct, the shorter the mixing zone. Vice versa, the longer and/or the more stagnating the mixing zone, the more will the first thermoplastic component and the at least one second thermoplastic component mix or blend such that their colors will fade in each other, due to the physical effect of subtractive color mixing. Therefore, this/these preferable, optional extrusion screw design(s) advantageously yield a high-output and, at the same time, high-quality manufacturing/injection-molding method/final product.

Preferably, the barrier-type extrusion screw design may include and/or be based on one or more of the three basic designs commonly known by their inventors' names, namely the so-called Maillefer barrier screw design, Schippers barrier screw design, and Dray barrier screw design; or combinations thereof. Firstly, the Maillefer barrier screw design relating to patent document CH 363149 A [the disclosure thereof being incorporated herewith by reference] discloses a barrier flight that retains unmelted solids in a primary channel while melted resin goes downstream in an auxiliary channel. Secondly, the Schippers barrier screw design relating to patent document DE 2017580 A1 [the disclosure thereof being incorporated herewith by reference] provides two different configurations: The first has parallel channels with the primary or entry channel reducing in depth while the auxiliary or melt channel (on the other side of the barrier flight) increases in depth. The second configuration adds distributive mixing by transposing the primary and the auxiliary flights. This causes the resin in the melt channel to mix with the resin on the trailing side of the primary channel. Thirdly, the Dray barrier screw design relating to patent document U.S. Pat. No. 3,650,652 A [the disclosure thereof being incorporated herewith by reference] discloses to provide a longer lead at the end of the feed section for increasing the melting area. The longer lead allows the auxiliary channel to be included, while the width of the solids bed in the primary channel remains unchanged.

Hence, the present disclosure provides a novel and innovative injection-molding technology development to create a bicolored (or multicolored) appearance, especially a marble-effect or marble-like effect in an injection-molded product. Thereby, the thermoplastic composition thereof comprises the first thermoplastic component/masterbatch of the first color (base color), and one (or multiple) second thermoplastic component(s) of another color that is different to the first color (of multiple other second colors that are different to the first color and mutually different/distinct from one another). The bi- or multicolored appearance means that there is at least one unmixed, especially unblended, regional domain of only the first or second color. Especially, the injection-molded product may appear to be made out of (artificial) marble or wood, in spite of its thermoplastic make/manufacturing origin from an injection-molding process.

As a key advantage, the injection-molded product according to the present disclosure is mechanically strong. Especially—significantly unlike previously known multi-color injection-molded articles—it does not suffer from detrimental delamination. Therefore it can be fully used for storage and/or transport applications, vehicle interior equipment, and the like. The superiority of the provided bi-/multicolored injection-molded in terms of mechanic strength and durability is founded, for one reason, in the technical feature according to which the first thermoplastic component and the at least one second thermoplastic component are mutually mixable, especially blendable and/or chemically compatible, materials, when in their thermoplastic melted states. This condition from interfacial as well as molecular chemistry/material science is especially met for the preferred embodiment wherein both (or all of) the first and (at least one) second thermoplastic components/masterbatches are (selected from/based on) the group of polyolefins. In other words, the presently disclosed development moves away from conventional injection-molding of chemically non-compatible mixtures of thermoplastic polymers (especially from non-polyolefin mixtures). For another reason, the good quality of the presently disclosed bi-/multicolored injection-molded product is founded in/caused by the optimized processing and chemical product design according to the provided injection-molding method and the preferred embodiments thereof. Last but not least, the possibility of manufacturing bi-/multicolored products by means of the presently disclosed injection-molding method instead of, for example conventional casting methods or traditional manual fabrication, enables an automated, cost-effective production of recyclable products.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Features, advantages, and technical and industrial significance of exemplary embodiments of the invention will be described below with reference to the accompanying drawings, in which like signs denote like elements, and wherein:

FIG. 1 is a photograph showing an injection-molded product of bicolored appearance according to a first embodiment that is injection-molded into the shape of a beverage crate;

FIG. 2 is a photograph showing a further injection-molded product of bicolored appearance according to a second embodiment that is injection-molded into the shape of a standard test sample for manufacturing engineering development (MED) purposes, whereby other influence parameters are identical to the ones relating to the first embodiment in FIG. 1;

FIG. 3 is a photograph showing a further injection-molded product of tri-colored appearance according to a third embodiment that is a further standard test sample for MED purposes;

FIG. 4 is a schematic diagram illustrating a configuration of an injection-molding machine (assembly) that is configured to process a corresponding method for manufacturing of the injection-molded product of bi- or multicolored appearance according to the disclosure, illustrating four different injection-molding process zones;

FIG. 5 is a flowchart of the method for manufacturing of the injection-molded product of bi- or multicolored appearance following the four different injection-molding process zones as illustrated in FIG. 4;

FIG. 6a and FIG. 6b are photographs showing further injection-molded products of bicolored appearance according to a fourth (“no. 4”) and a fifth embodiment (“no. 6”), respectively, that are further standard test samples for MED purposes, illustrating the effect of an experimental variation regarding the second Melt Flow Rate of the at least one second thermoplastic component;

FIGS. 7a, 7b and FIG. 7c are photographs showing further injection-molded products of bicolored appearance according to the fourth embodiment (“no. 4”, cf. FIG. 6a idem) as well as to a sixth (“no. 8”) and seventh (“no. 9”) embodiment, respectively, that are further standard test samples for MED development purposes, illustrating the effect of an experimental variation regarding different processing temperature ranges; and

FIG. 8a and FIG. 8b are photographs showing further injection-molded products of bicolored appearance according to an eighth (“no. 1”) and a ninth (“no. 2”) embodiment, respectively, that are further standard test samples for MED purposes, illustrating the effect of an experimental variation regarding the feed pellet size/diameter of the at least one second thermoplastic component.

### DETAILED DESCRIPTION

Features, advantages, and technical and industrial significance of exemplary embodiments of the invention will be described below with reference to the accompanying drawings, in which like signs denote like elements, and wherein:

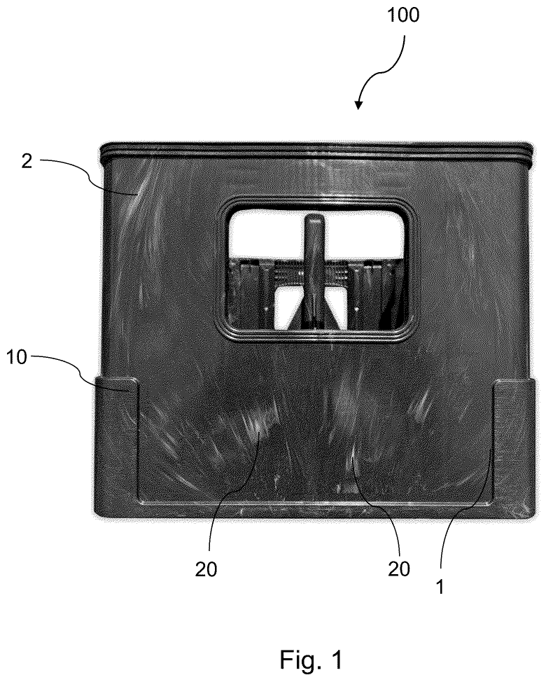

FIG. 1 is a photograph showing an injection-molded “marble-look” beverage crate 100 as an injection-molded product of bicolored appearance according to a first embodiment. The mechanically robust “marble-look” beverage/beer crate 100 of FIG. 1 resembles a final consumer product to be used for storage and transportation. The exemplary beverage/beer crate 100 of FIG. 1 has a width of 400 mm and a height of 270 mm.

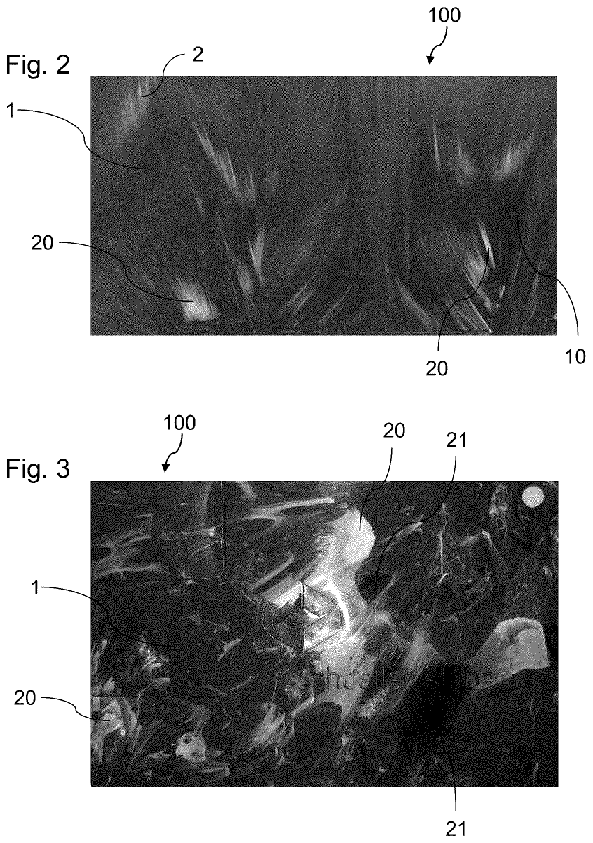

FIGS. 2, 3, 6a/6b, 7a/7b/7c, 8a/8b are respective photographs each showing a different standard test sample for manufacturing engineering development (MED) purposes 100 that resembles a further injection-molded product of bicolored appearance (FIG. 3: of tricolored appearance) according to a second to ninth embodiment, respectively. Each standard test sample (for MED) has a width of 100 mm and a height of 50 mm as well as a thickness (not shown) of 4 mm.

Each of the first to ninth embodiments of the injection-molded product of bi-/multicolored appearance 100 as shown in FIGS. 1, 2, 3, 6a/6b, 7a/7b/7c, 8a/8b include high-density polyethylene (HDPE) as a first thermoplastic component and polypropylene (PP) as the at least one second thermoplastic component. Therefore, they may be seen as an experimental series/design of experiments to observe the influence of certain parameters by comparison among one another, as will be detailed in the following.

By way of example/optionally, the high density polyethylene (HDPE) as the first thermoplastic component (base/outer phase) has been colored with a first color masterbatch made from PE (or PE copolymers/derivatives etc.) material as a first pigment carrier. Herein, the first color 1 is ocean blue (i.e. in the black and white reproduction: anthracite), as indicated in each of the first to ninth embodiments of the injection-molded product of bi-/multicolored appearance 100 shown in FIGS. 1, 2, 3, 6a/6b, 7a/7b/7c, 8a/8b. Accordingly, the regional domains of the first color 10 and/or a surrounding outer phase/matrix phase of the first thermoplastic component 1 (in the present case of a high percentage of the first thermoplastic component 1, more than 90 weight-%) can be recognized/identified by their ocean blue (i.e. in the black and white reproduction: anthracite) color.

By way of another example/optionally, the polypropylene as the (at least one) second thermoplastic component (effect/inner phase) has been colored with (at least one) second color masterbatch may from PP (or PP copolymers/derivatives etc.) material as a (at least one) second pigment carrier. Herein, the second color 2 is white (or, in addition, black, cf. FIG. 3), as indicated in each of the first to ninth embodiments of the injection-molded product of bi-/multicolored appearance 100 shown in FIGS. 1, 2, 3, 6a/6b, 7a/7b/7c, 8a/8b. Accordingly, the regional domains of the second color 20 can be recognized/identified by their white color.

The standard test sample (for MED) 100 of the second embodiment/FIG. 2 is essentially comparable to the beverage/beer crate 100 of the first embodiment/FIG. 1, insofar as other influence parameters besides the shape and size thereof may be considered as essentially identical or at least negligibly different. In consequence, the bicolored appearance of the second embodiment/FIG. 2, exhibiting multiple feather-like white streaks 20 as the regional domains of the second color 2, makes the impression of an enlarged detail of the photograph of the first embodiment/FIG. 1, while, in fact, it is not, but the two different objects of the larger crate versus the smaller standard test sample (for MED).

FIG. 3 relating to the third embodiment is unique [in comparison to the first, second and fourth to ninth embodiments the injection-molded product of bicolored appearance 100 as shown in FIGS. 1, 2, 6a/6b, 7a/7b/7c, 8a/8b] insofar as it gives an example of the injection-molded product being of a tricolored appearance/showing a marble-effect of altogether three distinctive colors ocean blue (anthracite)/white/black. That is, the tricolored appearance/marble-effect is produced as follows: the highly concentrated first thermoplastic component 1 is an essentially surrounding/outer phase of ocean blue (i.e. in the black and white reproduction: anthracite) as the first color, injection-molded together with two (separate) second thermoplastic components 2 as two (essentially separate) inner phases of white as well as of black constituting two different second colors 2. As a result, the tricolored appearance/marble-effect is created by visually distinct regional domains/patches/blobs/streaks that are ocean blue (i.e. in the black and white reproduction: anthracite) domains of the first color 10 as well as inner white domains 20 of one second color plus inner black domains 21 of (another) second color (i.e. of a third color).

According to the especially intended product use relating to storage and transportation, each of the first to ninth embodiments as shown in FIGS. 1, 2, 3, 6a/6b, 7a/7b/7c, 8a/8b underwent application test procedures, respectively, conducted to guarantee a respective mechanical strength/robustness and durability for each of the embodiments, at least for the time duration of a typical product life cycle/shelf-life. Thereby, for all of therefore-mentioned first to ninth embodiments it could be demonstrated/proven that these do not exhibit/undergo any delamination under static and/or dynamic mechanic stress, such as tensile loading. Instead, observable material breakdown occurs across the whole (bulk/interfaces) of the injection-molded product. In other words, each material of the first to ninth embodiments proves to behave/react/perform like an integral thermoplastic blend made from two or more thermoplastic polymers. Therefore, each of these embodiments can be considered “delamination-free” in the sense of the current disclosure.

For example, for the first embodiment (beer crate) and the second embodiment (standard test sample for MED, that resembles a detail of the first embodiment), the following test results were determined (according to the standard DIN test procedures known to the skilled person).

| | |
|---|---|
| Young's Modulus (MPa) | 1015 |
| Yield strength (MPa) | 23.8 |
| Yield strain (%) | 11 |
| Elongation (%) | 337 |
| Charpy Notched Impact (kJ/m²) | 7.0 |

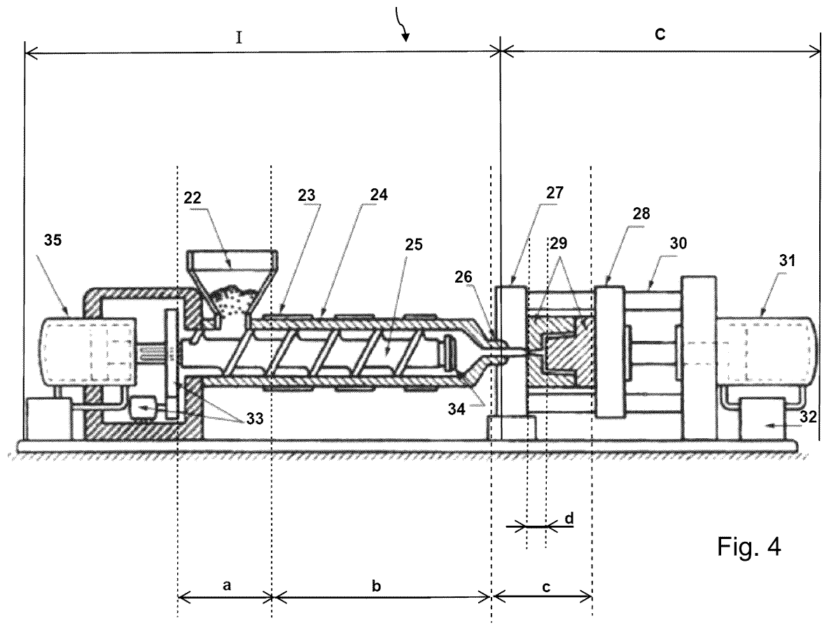

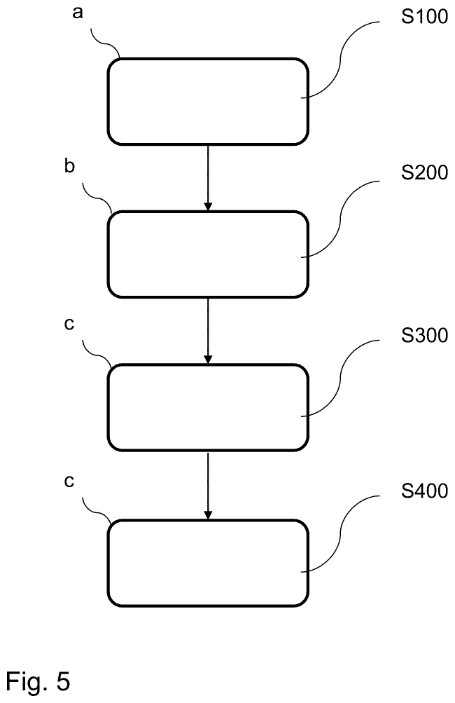

FIG. 4 shows a schematic diagram illustrating a preferred embodiment or a principal configuration of an injection-molding machine (assembly) 200. The injection-molding machine (assembly) 200 is configured to process/implement, as illustrated by a flowchart of corresponding FIG. 5, a corresponding method for manufacturing of the injection-molded product of bi- or multicolored appearance 100 according to the disclosure. Thereto, the injection-molding machine (assembly) 200 includes an injection unit I and a clamping unit C, as indicated by the double arrows in the upper part of FIG. 4. The clamping unit C is situated (esp. directly following) downstream of the injection unit I.

Furthermore, the injection-molding machine (assembly) 200 includes four different injection-molding process zones (designated by reference numerals a to d), as indicated by the double arrows in the bottom part of FIG. 4. Moreover, three out of these four different injection-molding process zones (i.e. a to c) are designated to four fundamental method steps S100 to S400 as distinguished by the flowchart of corresponding FIG. 5.

The injection unit I, on the left side of FIG. 4, comprises an initial feed hopper zone a and a (heated) barrel zone b, the latter being situated (esp. directly following) downstream of the feed hopper zone a. The clamping unit C, on the right side of FIG. 4, comprises an injection mold zone c. The injection mold zone c includes an injection mold 29 (having male and female mold halves) and, upstream thereof, an injection-nozzle 26. The injection nozzle 26 is provided at the downstream end of the heated barrel 24. As can be seen in FIG. 4, the injection mold zone c comprises an optional, so-called hot-runner zone d. The hot-runner zone d is located at an entrance flow region of the injection mold 29.

The feed hopper zone a is configured such that feeding (step S100 of FIG. 5), especially dry mixing, of the respective (thermoplastic) materials (respective matrix materials and corresponding masterbatches)/first and second thermoplastic components takes place (in a preferably continuous process).

Then/downstream, the barrel zone b is configured such that heating and extrusion (step S200 of FIG. 5) for plasticizing/mixing (and partial non-mixing of remaining domains, according to the present disclosure) of the respective (thermoplastic) materials (respective matrix materials and corresponding masterbatches)/first and second thermoplastic components takes place.

Then/downstream, the injection mold zone c is configured such that the injection-molding step (step S300 of FIG. 5) takes place whereby a melted composition of/with the first and second thermoplastic components is injected through the injection nozzle 26 into the injection mold 29 (in its closed state), in a timely cycled manner. In addition, a nonreturn valve 34 is provided to prevent back-flow of the melted composition.

As can further be seen in FIG. 4, the injection mold 29 is arranged between a stationary platen 27 and a movable platen 28. By (e.g. horizontal) movement of the movable platen 28 the male mold halve can be moved into the corresponding female mold halve and out of it, in a timely cycled manner (each time for method steps S300 and S400, cf. FIG. 5), to close and open the injection mold 29. This is accomplished by the provision of, e.g. four, tie rods 30, clamping cylinder 31 and hydraulic cylinder 32.

Within the injection-molding step (S300, cf. FIG. 5), the optional hot-runner zone d is configured to further heat up, especially by intensive heating/heat transfer and/or for a comparably short injection time/residence time (in order to avoid thermal degradation), the melted composition of/with the first and second thermoplastic components of the injection mold 29, for example by a hot runner temperature at ca. 215° C. and/or for 2.5 seconds injection time. Afterwards, the injection mold 29 is cooled such that solidification (step S400 of FIG. 5) into the final injection-molded product and subsequent unloading thereof takes place, in a timely cycled manner.

As can further be seen in FIG. 4, the injection unit I includes a feed hopper 22, thereby defining the feed hopper zone a. Into the feed hopper 22 the first thermoplastic component and the at least one second thermoplastic component are fed, especially in the form of solid thermoplastic/polymer pellets.

Then, the heated barrel zone b provides a barrel 24 heated e.g. from the outside by multiple circumferentially arranged heaters 23. The barrel 24 is a hollow chamber in which the (at least one) extrusion screw 25 (also referred to as: reciprocating injection screw) operates. The barrel 24 is heated by at least one heater 23 arranged to provide a temperature profile (extending along a longitudinal barrel axis/extrusion screw axis). The extrusion screw/reciprocating screw 24 is a screw capable of both rotational and axial movement. Thereto, the injection-molding machine (assembly) 200 includes a motor/gears for screw rotation 33 and a cylinder for screw ram 35, arranged upstream of the feed hopper zone a. The extrusion screw 25, arranged within the heated barrel zone b of the injection unit I, is configured to combine heating and mixing with the function of injection. In a one preferred single-screw-extruder embodiment of the extrusion screw/reciprocating screw 25 that uses one/a single extrusion screw 25, the barrel 24 has a cylindrical cross-section. Alternatively, in another preferred double-screw-extruder embodiment of the extrusion screw/reciprocating screw 25 that uses two extrusion screws 25, the barrel 24 has a figure-eight cross-section.

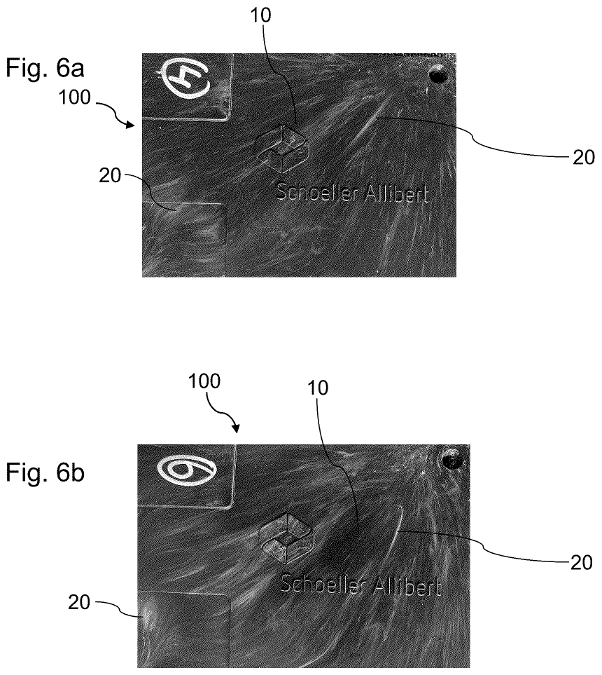

Coming back to the series/design of experiments as afore-mentioned in the context of the previous discussion of FIGS. 1, 2, 3, 6a/6b, 7a/7b/7c, 8a/8b, each of FIGS. 6a to 8b shows, respectively, the standard test sample (for MED) 100 according to the variation of the following embodiments, as now to be further discussed:

FIG. 6a and FIG. 6b relate to standard test samples 100 according to a fourth (“no. 4”) and a fifth embodiment (“no. 6”), respectively, thereby illustrating the effect of an experimental variation regarding the second Melt Flow Rate (MFR) of the at least one second thermoplastic component. That is, the fourth embodiment (“no. 4”/FIG. 6a) is manufactured based on the second Melt Flow Rate (MFR) being 0.5 g/10 min, measured at 2.16 kg test load and at 230° C. test temperature (determined according to DIN EN ISO 1133, group of polypropylenes). Contrary to this, the fifth embodiment (“no. 6”/FIG. 6b) is manufactured based on the second Melt Flow Rate (MFR) being 2.0 g/10 min, likewise measured at 2.16 kg test load and at 230° C. test temperature. From the comparison of FIGS. 6a vs. 6b it can be concluded that the higher the second MFR, i.e. the lower the second melt viscosity, the easier the white second thermoplastic component (masterbatch) mixes with the surrounding blue first thermoplastic component (masterbatch). This conclusion is made, since from the overall bicolored appearance of the fifth embodiment (“no. 6”/FIG. 6b) it seems that the “ocean blue” (b/w: anthracite) is lighter than for the fourth embodiment (“no. 4”/FIG. 6a). In other words, the higher the second MFR, i.e. the lower second melt viscosity, disperses better and easier, resulting in (more) mixing with the blue masterbatch.

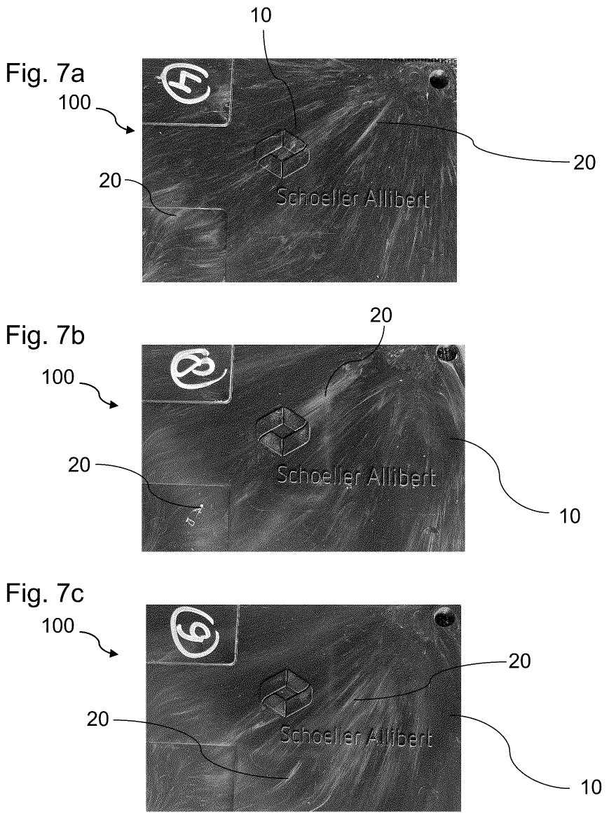

FIG. 7a, 7b and FIG. 7c are photographs showing further bicolored standard test samples 100 according to the fourth embodiment (“no. 4”, cf. FIG. 6a idem) as well as to a sixth (“no. 8”) and seventh (“no. 9”) embodiment, respectively, that are further standard test samples (for MED) development purposes, illustrating the effect of an experimental variation regarding different processing temperature ranges, herein especially the effect of different melt composition/mass temperatures. Thereby, as previously explained, injection-molding process influence parameters comprise the injection speed, an injection temperature, a melt composition/mass temperature average, the temperature profile within the heated barrel zone (all afore-mentioned temperature ranges), and the hot runner temperature.

That is, the fourth embodiment (“no. 4”, FIG. 7a, cf. FIG. 6a idem) is manufactured at a temperature of 185° C. to 195° C. The sixth embodiment (“no. 8”, FIG. 7b) is manufactured at a temperature of 195° C. to 205° C. The seventh embodiment (“no. 9”, FIG. 7c) is manufactured at a temperature of 210° C.-220° C. Hence, it is concluded that with increase in temperature, the marble-effect/the non-mixing of the inner second thermoplastic component (“effect masterbatch”) gets disturbed through the heated extrusion mixing. In other words, the hotter the more mixes the inner phase/second thermoplastic component (“effect masterbatch”) with the outer phase/matrix material/first thermoplastic component. The marble-effect, as defined by the appearance of the first and second regional domains 10, 20, becomes ‘less’ sharply defined/distinguishable and more faded/gradient.

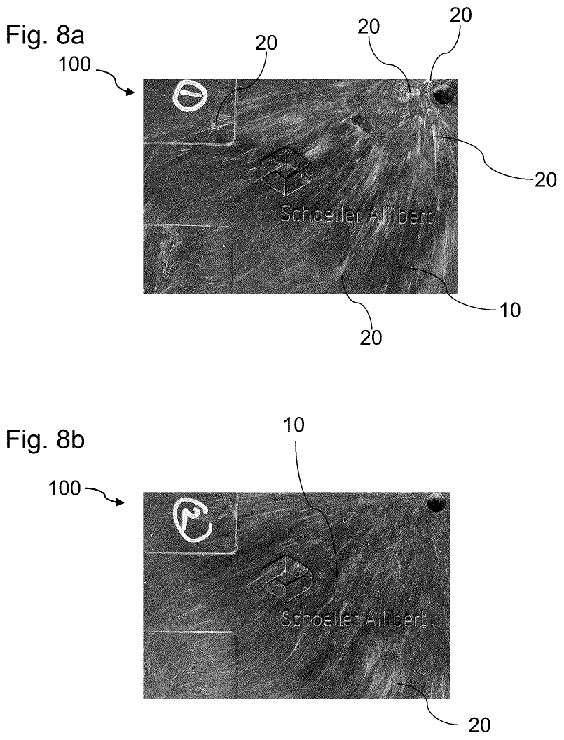

FIG. 8a and FIG. 8b are photographs showing further bicolored standard test samples 100 according to the eighth (“no. 1”) and the ninth (“no. 2”) embodiment, respectively, illustrating the effect of an experimental variation regarding the feed pellet size/diameter of the at least one second thermoplastic component. That is, the eight embodiment (“no. 1”, FIG. 8a) is manufactured based on a “triple in size” pellet size. The ninth embodiment (“no. 2”, FIG. 8b) is manufactured based on a standard pellet size (ca. 3 mm). As defined by the appearance of the first and second regional domains 10, 20, it may be concluded that the larger the pellet size, the more colorant/pigment amount there is to create the desired marble-effect visually standing out from the outer phase/matrix material/first thermoplastic component. That is, then the effect of the colorants/pigments is comparably larger.

### LIST OF REFERENCE NUMERALS

1 first thermoplastic component
2 second thermoplastic component
10 domain of first color
20 domain of (one) second color
21 domain of (another) second color (i.e. of a third color)
22 feed hopper
23 heaters
24 barrel
25 extrusion screw (reciprocating)
26 injection nozzle
27 stationary platen
28 movable platen
29 injection mold
30 tie rods
31 clamping cylinder
32 hydraulic cylinder
33 motor and gears for screw rotation
34 nonreturn valve
35 cylinder for screw-ram
100 injection-molded product of bi- or multicolored appearance
200 injection-molding machine
a feed hopper zone
b barrel zone
C injection mold zone
d hot runner zone
C clamping unit
I injection unit
S100-S400 process steps of the injection-molding method

1.-15. (canceled)

16. An injection-molded product of bicolored or multicolored appearance, the injection-molded product comprising:
a first thermoplastic component of a first color that is a base color;
at least one second thermoplastic component of a second color that is different from the first color; and
at least one unmixed regional domain of only one of the first color and the second color, the at least one unmixed regional domain being uncontaminated by and/or visually distinct from the other of the first color and the second color,
the first thermoplastic component and the at least one second thermoplastic component comprising mutually mixable materials when in thermoplastic melted states.

17. The injection-molded product of bicolored or multicolored appearance according to claim 16, wherein the first thermoplastic component is obtained from at least a base polymer selected from the group of polyethylenes and derivatives and/or compounds thereof.

18. The injection-molded product of bicolored or multicolored appearance according to claim 17, wherein the first thermoplastic component has a high first melt flow rate, as determined according to DIN EN ISO 1133, that is in a range of 15 to 50 g/10 min, measured at 2.16 kg test load and at 190° C. test temperature.

19. The injection-molded product of bicolored or multicolored appearance according to claim 16, wherein the at least one second thermoplastic component is obtained from at least a base polymer selected from the group of polypropylenes and derivatives and/or compounds thereof.

20. The injection-molded product of bicolored or multicolored appearance according to claim 19, wherein the at least one second thermoplastic component has a low second melt flow rate, as determinable according to DIN EN ISO 1133, that is in a range of 0.5 to 5.0 g/10 min, measured at 2.16 kg test load and at 230° C. test temperature.

21. The injection-molded product of bicolored or multicolored appearance according to claim 16, wherein:
the first thermoplastic component has a high first melt flow rate, as determined according to DIN EN ISO 1133, that is in a range of 15 to 50 g/10 min, measured at 2.16 kg test load.

22. The injection-molded product of bicolored or multicolored appearance according to claim 16, wherein:
the at least one second thermoplastic component has a low second melt flow rate, as determinable according to DIN EN ISO 1133, that is in a range of 0.5 to 5.0 g/10 min, measured at 2.16 kg test load.

23. The injection-molded product of bicolored or multicolored appearance according to claim 16, wherein:
the first thermoplastic component has a first melting point or melting point interval, as determinable by differential scanning calorimetry according to DIN EN ISO 11357, that is in a temperature range of 110 to 140° C.; and
the at least one second thermoplastic component has a second melting point or melting point interval, as determinable by differential scanning calorimetry according to DIN EN ISO 11357, that is in the temperature range of 156 to 210° C.

24. The injection-molded product of bicolored or multicolored appearance according to claim 23, wherein the first melting point or melting point interval and the second melting point or melting point interval do not overlap.

25. The injection-molded product of bicolored or multicolored appearance according to claim 16, wherein the at least one second thermoplastic component has a second mass percentage in a range of 0.1 to 5 weight-%.

26. The injection-molded product of bicolored or multicolored appearance according to claim 16, wherein the injection-molded product of bicolored or multicolored appearance is plasticizer-free.

27. The injection-molded product of bicolored or multicolored appearance according to claim 16, wherein, for creating an artificial marble appearance or an artificial wood appearance:
the first thermoplastic component is high density polyethylene, a masterbatch of the first color is made from a polyethylene pigment carrier, and the second color is made from a polypropylene pigment carrier; or
the first thermoplastic component is polypropylene, a masterbatch of the first color is made from a polypropylene pigment carrier, and the second color is made from a high density polyethylene pigment carrier.

28. The injection-molded product of bicolored or multicolored appearance according to claim 16, wherein the injection-molded product is a container, a pallet, a crate and/or a peg for storage and/or transportation of goods.

29. The injection-molded product of bicolored or multicolored appearance according to claim 16, wherein the first thermoplastic component and/or the at least one second thermoplastic component contains:
at least 90% of a recycled material; and/or
at least 5% of a maritime material.

30. The injection-molded product of bicolored or multicolored appearance according to claim 16, wherein the injection-molded product is delamination-proof, and wherein the injection-molded product comprises one or more of the following material strength parameters or test values:
Young's Modulus value of at least 800 MPA;
yield strength value of at least 20 MPa;
yield strain value of at least 10%;
elongation value of at least 250%;
Charpy V-notch impact test value of at least 6 KJ/m².

31. A method of manufacturing the injection-molded product of bicolored or multicolored appearance according to claim 16, the method comprising the steps of:
feeding, within a feed hopper zone of an injection molding machine, the first thermoplastic component and the at least one second thermoplastic component, respectively, into at least one feed hopper to attain a thermoplastic material composition;
extruding the thermoplastic material composition continuously, within a heated barrel zone extending between the feed hopper zone and an injection nozzle of the injection molding machine, via and along a longitudinally extending extrusion screw to be mixed and plasticized into a molten state;
injection-molding, within an injection mold zone, the thermoplastic material composition, through the injection nozzle into an injection mold, in a timely cycled manner; and
solidifying the thermoplastic material composition into the injection-molded product by cooling of the injection mold and subsequent unloading, in a timely cycled manner.

32. The method of manufacturing according to claim 31, wherein:
the first thermoplastic component has a first melting point, and the at least one second thermoplastic component has a second melting point; and
the heated barrel zone provides a process temperature profile that is higher than the first melting point and higher than the second melting point.

33. The method of manufacturing according to claim 31, wherein the heated barrel zone provides a process temperature profile that is set to be in a first part of the heated barrel zone at a first temperature range of 160 to 165° C. and/or in a middle part of the heated barrel zone at a second temperature range of 165 to 175° C., and/or in a last part of the heated barrel zone at a third temperature range of 175 to 195° C.

34. The method of manufacturing according to claim 31 wherein the heated barrel zone provides a process temperature profile that includes a temperature maximum within a hot runner zone that is included within the injection mold zone, set at a temperature range of 185 to 195° C.

35. The method of manufacturing according to claim 31, wherein the longitudinally extending extrusion screw:
has a screw length;
is configured to provide a short mixing zone with a mixing zone length, the mixing zone length extending maximally up to 30% of the screw length; and/or
is a barrier-type extrusion screw.
